(19) United States
(12) Patent Application Publication
(10) Pub. No.: US 2015/0317263 A1
(43) Pub. Date: Nov. 5, 2015

(54) SYSTEMS AND METHODS FOR CONTROLLING A MEMORY PERFORMANCE POINT

(71) Applicant: TEXAS INSTRUMENTS INCORPORATED, Dallas, TX (US)

(72) Inventors: David Joseph DERRICK, Allen, TX (US); Donald Richard TILLERY, JR., Murphy, TX (US); Patrick Claude TITIANO, Alpes-Maritimes (FR)

(21) Appl. No.: 14/266,274

(22) Filed: Apr. 30, 2014

(51) Int. Cl. G06F 13/16; G06F 1/28; G06F 13/42

(52) U.S. Cl. CPC G06F 13/1668; G06F 13/4221; G06F 1/28

(57) ABSTRACT

A system includes a processor, memory coupled to the processor by way of an interconnect, and monitoring hardware coupled to the interconnect. The memory operates at least at a first and second performance point where the first performance point has a higher performance than the second performance point. The monitoring hardware monitors transactions on the interconnect to a detect usage level of the interconnect and transmits an indication of the detected usage level to control logic. Based on the detected usage level being above a first threshold, the control logic causes the memory to operate at the first performance point. Based on the detected usage level being below a second threshold, the control logic causes the memory to operate at the second performance point. The second threshold is equal to or less than the first threshold.

### CROSS-REFERENCE TO RELATED APPLICATIONS

None.

### BACKGROUND

Modern computers include processors and memory (e.g., random access memory (RAM)) that may operate at different voltage and/or frequency levels, or “performance points.” Power consumption of these devices is related to the performance point at which they operate; that is, a processor or memory device operating at a higher performance point consumes more power while a processor or memory device operating at a lower performance point consumes less power. Thus, power consumption may be reduced by allowing both the processor and memory device to operate at the lowest performance point permitted for a given computing load.

### BRIEF DESCRIPTION OF THE DRAWINGS

For a detailed description of exemplary embodiments of the invention, reference will now be made to the accompanying drawings in which:

FIG. 1a shows a block diagram of a computing system in accordance with various embodiments of the present disclosure;

FIG. 1b shows a block diagram of an alternate embodiment of a computing system in accordance with various embodiments of the present disclosure;

FIG. 2 shows a flow chart of a method in accordance with various embodiments of the present disclosure;

FIG. 3 shows a block diagram of a system to control a memory performance point in accordance with various embodiments of the present disclosure; and

FIG. 4 shows a block diagram of another example system to control a memory performance point in accordance with various embodiments of the present disclosure.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In computing systems, processors such as central processing units (CPUs) are configured to operate at multiple combinations of clock frequency and power supply voltage, or performance points. For example, in a time period where processing requirements on a CPU are high, the CPU may operate at a higher frequency-voltage combination, whereas in a time period where processing requirements on the CPU are minimal, the CPU may operate at a lower frequency-voltage combination, which conserves power. In this way, power consumption of the CPU is reduced when processing requirements on that CPU are lessened.

Similarly, memory such as random access memory (RAM) may be configured to operate at multiple performance points as well. The performance point of the memory is, in some cases, based on the requirements of the CPU. For example, when the CPU is operating at a higher performance point, the memory may also be caused to operate at a correspondingly higher performance point. However, in other cases, the performance point of the memory does not necessarily correspond to the performance point of the CPU. For example, where multiple CPUs are using memory, even where the CPUs are operating at a lower performance point, the memory may be caused to operate at a higher performance point to ensure adequate performance for all CPUs. Thus, in these cases, when the CPU is able to operate at a lower performance point, the memory does not necessarily transition to a lower performance point, and thus consumes more power than is necessary for a given CPU performance point. Further, in certain other cases, the CPU may be at a higher performance point but actually does not require memory to be at a correspondingly high performance point, for example because the CPU is accessing cache rather than memory. It is thus desirable to provide a system and method that allow and cause the memory to operate at a lower performance point when system processing requirements do not necessitate the memory operate at a higher performance point to provide acceptable system performance, in particular to decrease excess power consumption when not necessary.

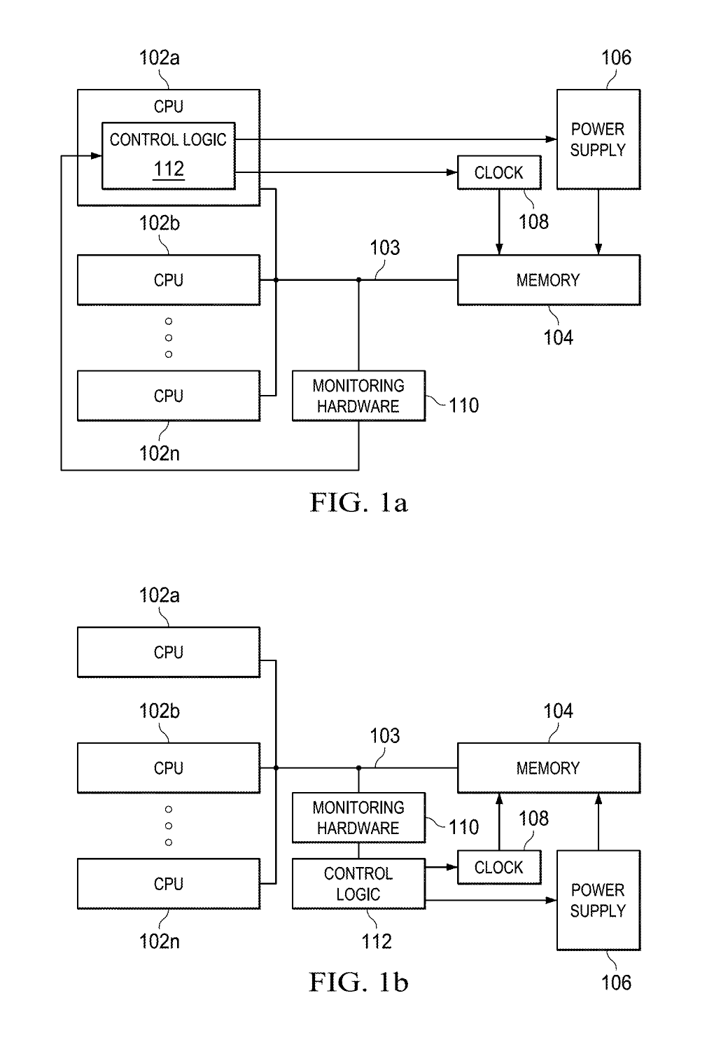

Turning to FIG. 1a, a computing system 100 is shown in accordance with various embodiments. The computing system 100 includes one or more CPUs 102a, 102b, . . . , 102n coupled to a memory 104 by way of an interconnect 103. In certain embodiments, only one CPU 102 is present, although one skilled in the art will appreciate that more than one CPU 102 may be included for increased processing ability. In the case where multiple CPUs 102 are present, one CPU 102a may be a master while the other CPUs 102b-n are slaves. A power supply 106 supplies the memory 104 with one or more voltages, which may vary depending on the performance point at which the memory 104 is to operate. Similarly, a clock circuit 108 supplies the memory 104 with a clock signal (e.g., generated using a digital phase-locked loop (DPLL)) having a variable frequency depending on the performance point at which the memory 104 is to operate.

In accordance with various embodiments, monitoring hardware 110 is coupled to the interconnect 103 and detects a usage level of the interconnect 103. In some embodiments, the usage level may be expressed as a utilization percentage, while in other embodiments the usage level may be expressed as a bandwidth (e.g., MB/sec). The monitoring hardware 110 generates and transmits an indication of the detected usage level to control logic 112, which in FIG. 1a is software that is executed by CPU 102a. In the case of multiple CPUs 102, the control logic 112 may be executed by the CPU 102a that is the master. By monitoring the actual usage of the interconnect 103 between the CPUs 102 and the memory 104, a more accurate representation of a required memory performance point for given processing tasks is made available.

The control logic 112 causes the memory 104 to operate at a particular performance level based on the detected usage level or the indication of the detected usage level generated by the monitoring hardware 110. In accordance with various embodiments, if the detected usage level is above a first threshold, then the control logic 112 causes the memory 104 to operate at a first, higher performance point. However, if the detected usage level is below a second threshold, then the control logic 112 causes the memory 104 to operate at a second, lower performance point.

The particular values of the first and second threshold may be selected to optimize overall system 100 performance. For example, in some embodiments the first and second thresholds may be equal (e.g., 50% interconnect 103 utilization), such that if interconnect 103 utilization is greater than 50%, the control logic 112 causes the memory 104 to operate at the first performance point and if interconnect 103 utilization is less than 50%, the control logic 112 causes the memory 104 to operate at the second performance point. However, in other embodiments, the second threshold may be less than the first threshold (e.g., the first threshold is 70% interconnect 103 utilization and the second threshold is 30% interconnect 103 utilization), to allow for some hysteresis in the system 100. For example, if the control logic 112 causes the memory 104 to operate at the first performance point and the interconnect 103 utilization falls below 70%, but not below 30%, the control logic 112 continues to cause the memory 104 to operate at the first performance point.

The frequency of the clock signal generated by clock circuit 108 may be altered by modifying registers internal to the clock circuit 108, which in turn modifies the DPLL or an external divider on the output of the DPLL. The voltage supplied by the power supply 106 may be altered based on communications received through an interface, for example a serial peripheral interface (SPI) or an inter-integrated circuit (I2C) interface. The control logic 112 causes the clock circuit 108 to generate a clock signal for the memory 104 having a frequency value that is based on the detected usage level, for example by modifying registers of the clock circuit 108. Similarly, the control logic 112 also causes the power supply 106 to supply an operating voltage to the memory 104 having a voltage value that is based on the detected usage level, for example through communications via a SPI or I2C interface.

In some embodiments, the control logic 112 causes the memory 104 to operate at a higher or lower performance point based on the detected usage level being above the first threshold or below the second threshold, respectively, for at least a predetermined time. For example, if the memory 104 is operating at the lower performance point and the detected usage level rises above the first threshold, but for less than the predetermined threshold amount of time, and then falls below the first threshold, the control logic 112 would not cause the memory 104 to operate at the higher performance point. Conversely, if the memory 104 is operating at the lower performance point and the usage level rises above the first threshold and remains there for at least the predetermined threshold amount of time, the control logic 112 causes the memory 104 to operate at the higher performance point.

In certain embodiments, the various parameters described above with respect to the control logic 112 may be configurable, either at the time of system 100 design, by a user of the system 100, or both. For example, the various usage level thresholds may be configured, the predetermined threshold amounts of time may be configured, and other such parameters may be similarly configured. Additionally, although described generally with respect to a higher and lower performance point, one of ordinary skill in the art will appreciate that the present disclosure may be similarly applied to three or more performance points.

Turning now to FIG. 1b, an alternate embodiment of a system 150 is shown in accordance with various embodiments. In FIG. 1a, the control logic 112 was executed by the CPU 102a, which is the master in a multiprocessor system 100. As a result, in situations where the master CPU 102a is not active but one or more of the other CPUs 102b-n necessitate the memory 104 to operate at a higher performance point, the CPU 102a must be woken up to execute the control logic 112 to cause the memory 104 to operate at the higher performance point. Requiring a dormant master CPU 102a to wake up to perform this task consumes additional power, which is disadvantageous. Thus, in FIG. 1b, the control logic 112 is implemented as dedicated hardware, such as a microcontroller or hardware state machine, which consume less power than a CPU 102. This avoids the need to wake up a CPU 102 to implement the control of the performance point of the memory 104. As a result, the power consumption of 150 is reduced, in particular in scenarios where the master CPU 102a is dormant but one or more of the other CPUs 102b-n require the memory 104 to operate at a higher performance point. Aside from this difference, the elements shown in FIG. 1b operate similarly to those explained above with respect to FIG. 1a.

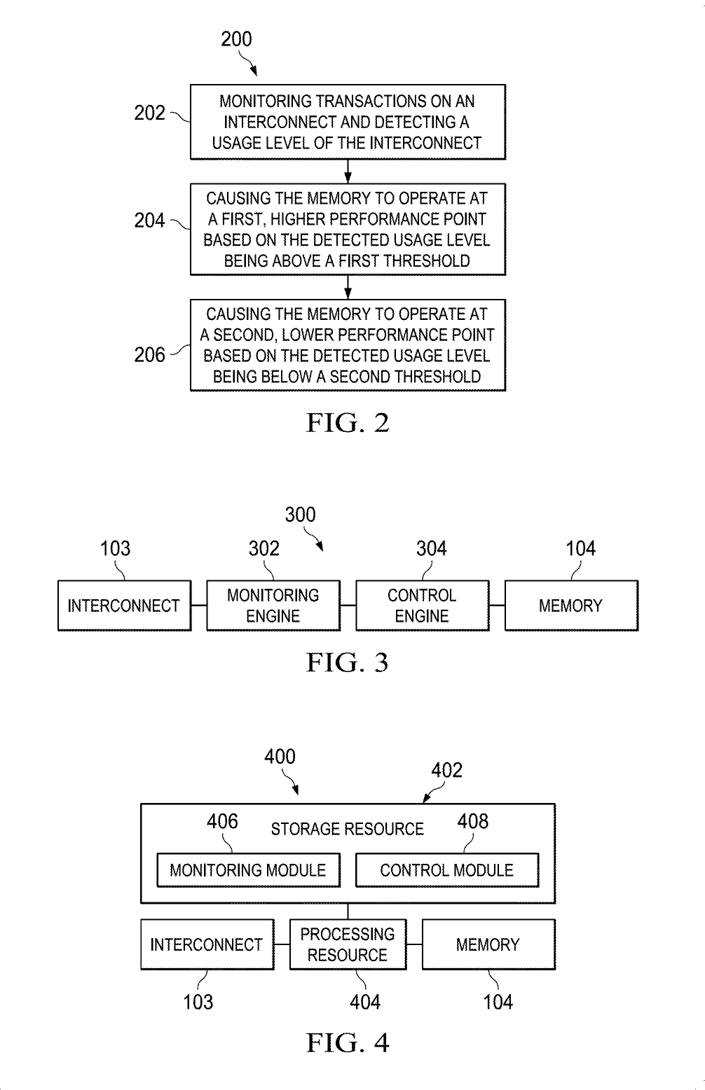

FIG. 2 shows a method 200 in accordance with various embodiments. The method 200 begins in block 202 with monitoring transactions on an interconnect 103 and detecting a usage level of the interconnect 103 that couples processors 102 to memory 104. As explained above, monitoring hardware 110 may be implemented to detect interconnect 103 usage, for example as a percent utilization value or as a bandwidth value. The method 200 continues in block 204 with causing the memory 104 to operate at a first, higher performance point based on the detected usage level being above a first threshold. In block 206, the method 200 includes causing the memory 104 to operate at a second, lower performance point based on the detected usage level being below a second threshold.

Control logic 112, which may be software executed by one of the CPUs 102 or hardware logic such as a microcontroller, implements this control of the performance point of the memory 104 by interfacing with a clock circuit 108 to vary the frequency of a clock signal provided to the memory 104 and by interfacing with a power supply 106 to vary the voltage level being supplied to the memory 104. In some cases the first and second thresholds are equal, while in others the second threshold is less than the first threshold to introduce an amount of hysteresis to the performance point control. Additionally, in certain embodiments, the method 200 includes causing the memory 104 to operate at the first performance point only when the detected usage is above the first threshold for at least a predetermined amount of time. Similarly, the method 200 may include causing the memory 104 to operate at the second performance point only when the detected usage is below the second threshold for at least a predetermined amount of time.

Turning now to FIG. 3, a system 300 to control a memory performance point is shown. As shown, the system 300 includes monitoring engine 302 and a control engine 304. The monitoring engine 302 is connected to interconnect 103 and monitors a usage level of the interconnect 103. The control engine 304 is coupled to memory 104 controls the performance point of the memory 104. The monitoring engine 302 and the control engine 304 are combinations of programming and hardware to execute the programming. Although shown separately, the monitoring engine 302 and the control engine 304 are not required to represent separate pieces of software programming. For example, each engine 302, 304 may share a common processor and memory, although this is not required. Additionally, the programming that enables the functionality of each engine 302, 304 may be included in the same executable file or library.

The monitoring engine 302 monitors transactions occurring on the interconnect 103 and, based on these transactions, detects a usage level of the interconnect 103. The monitoring engine transmits an indication of the usage level to the control engine 304. The control engine 304 causes the memory 104 to operate at a first, higher performance point based on the detected usage level being above a first threshold and causes the memory 104 to operate at a second, lower performance point based on the detected usage level being below a second threshold. As explained above, the second threshold is less than or equal to the first threshold.

FIG. 4 shows another example of a system 400 to control a memory performance point. The system 400 includes a storage resource 402 coupled to a processing resource 404. The processing resource 404 may be a single processor, a group of distributed processor, a single computer, or a plurality of computers. The storage resource 402 includes one or more local or distributed volatile storage devices (e.g., RAM) and/or non-volatile storage devices (e.g., HDD, flash storage, etc.) and comprises a monitoring module 406 and a control module 408. Thus, the storage resource 402 and the processing resource 404 are hardware components of the system 400. The system 400 also includes an interconnect and a memory as above, but which are not shown for simplicity.

Each module 406, 408 represents instructions that, when executed by the processing resource 404, implements an associated engine. For example, when the monitoring module 406 is executed by the processing resource 404, the above-described monitoring engine 302 functionality is implemented. Similarly, when the control module 408 is executed by the processing resource 404, the above-described control engine 304 functionality is implemented. The modules 406, 408 may also be implemented as an installation package or packages stored on the storage resource 402, which may be a CD/DVD or a server from which the installation package may be downloaded.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system, comprising:
a processor;
memory coupled to the processor by way of an interconnect, the memory configured to operate at least at a first and second performance point, the first performance point having a higher performance than the second performance point; and
monitoring hardware coupled to the interconnect, the monitoring hardware configured to:
monitor transactions on the interconnect to a detect usage level of the interconnect; and
transmit an indication of the detected usage level to control logic, the control logic configured to:
based on the detected usage level being above a first threshold, cause the memory to operate at the first performance point; and
based on the detected usage level being below a second threshold, cause the memory to operate at the second performance point;
wherein the second threshold is equal to or less than the first threshold.

2. The system of claim 1 further comprising a clock circuit coupled to the memory to supply a clock signal to the memory, wherein the first and second performance points each comprise a frequency value and wherein the control logic causes the clock circuit to:
generate a clock signal corresponding to the frequency value of the first performance point based on the detected usage level being above the first threshold; and
generate a clock signal corresponding to the frequency value of the second performance point based on the detected usage level being below the second threshold.

3. The system of claim 1 further comprising a power supply coupled to the memory to supply an operating voltage to the memory, wherein the first and second performance points each comprise a voltage value and wherein the control logic causes the power supply to:
supply an operating voltage corresponding to the voltage value of the first performance point based on the detected usage level being above the first threshold; and
supply an operating voltage corresponding to the voltage value of the second performance point based on the detected usage level being below the second threshold.

4. The system of claim 1 wherein the control logic is further configured to:
based on the detected usage level being above the first threshold for at least a predetermined amount of time, cause the memory to operate at the first performance point; and
based on the detected usage level being below the second threshold for at least a predetermined amount of time, cause the memory to operate at the second performance point.

5. The system of claim 1 wherein the second threshold is less than the first threshold and the control logic is further configured to:
cause the memory to transition from the first performance point to the second performance point based on the detected usage falling below the second threshold; and
cause the memory to transition from the second performance point to the first performance point based on the detected usage rising above the first threshold.

6. The system of claim 1 wherein the control logic comprises software executed by the processor.

7. The system of claim 1 wherein the control logic comprises one or more hardware logic elements separate from the processor.

8. The system of claim 7 wherein the one or more hardware logic elements comprise a state machine or a microcontroller.

9. The system of claim 1 wherein the usage level comprises a utilization percentage or a bandwidth value.

10. A method, comprising:
monitoring transactions on an interconnect and detecting usage level of the interconnect, wherein the interconnect couples a memory to a processor;
based on the detected usage level being above a first threshold, causing the memory to operate at a first performance point; and
based on the detected usage level being below a second threshold, causing the memory to operate at a second performance point;
wherein the first performance point has a higher performance than the second performance point; and
wherein the second threshold is equal to or less than the first threshold.

11. The method of claim 10 wherein the first and second performance points each comprise a frequency value and the method further comprises:
generating, by a clock circuit coupled to the memory, a clock signal corresponding to the frequency value of the first performance point based on the detected usage level being above the first threshold; and
generating, by the clock circuit, a clock signal corresponding to the frequency value of the second performance point based on the detected usage level being below the second threshold.

12. The method of claim 10 wherein the first and second performance points each comprise a voltage value and the method further comprises:
supplying, by a power supply coupled to the memory, an operating voltage corresponding to the voltage value of the first performance point based on the detected usage level being above the first threshold; and
supplying, by the power supply, an operating voltage corresponding to the voltage value of the second performance point based on the detected usage level being below the second threshold.

13. The method of claim 10 further comprising:
based on the detected usage level being above the first threshold for at least a predetermined amount of time, causing the memory to operate at the first performance point; and
based on the detected usage level being below the second threshold for at least a predetermined amount of time, causing the memory to operate at the second performance point.

14. The method of claim 10 wherein the second threshold is less than the first threshold and the method further comprises:
causing the memory to transition from the first performance point to the second performance point based on the detected usage falling below the second threshold; and
causing the memory to transition from the second performance point to the first performance point based on the detected usage rising above the first threshold.

15. A system, comprising:
hardware logic including monitoring logic and control logic, the monitoring logic configured to:
monitor transactions on an interconnect between a processor and memory to detect a usage level of the interconnect; and
transmit an indication of the detected usage level to the control logic, the control logic configured to:
based on the detected usage level being above a first threshold, cause the memory to operate at the first performance point; and
based on the detected usage level being below a second threshold, cause the memory to operate at the second performance point;
wherein the second threshold is equal to or less than the first threshold.

16. The system of claim 15 wherein the first and second performance points each comprise a frequency value and wherein the control logic causes a clock circuit coupled to the memory to:
generate a clock signal corresponding to the frequency value of the first performance point based on the detected usage level being above the first threshold; and
generate a clock signal corresponding to the frequency value of the second performance point based on the detected usage level being below the second threshold.

17. The system of claim 15 wherein the first and second performance points each comprise a voltage value and wherein the control logic causes a power supply coupled to the memory to:
supply an operating voltage corresponding to the voltage value of the first performance point based on the detected usage level being above the first threshold; and
supply an operating voltage corresponding to the voltage value of the second performance point based on the detected usage level being below the second threshold.

18. The system of claim 15 wherein the control logic is further configured to:
based on the detected usage level being above the first threshold for at least a predetermined amount of time, cause the memory to operate at the first performance point; and
based on the detected usage level being below the second threshold for at least a predetermined amount of time, cause the memory to operate at the second performance point.

19. The system of claim 15 wherein the second threshold is less than the first threshold and the control logic is further configured to:
cause the memory to transition from the first performance point to the second performance point based on the detected usage falling below the second threshold; and
cause the memory to transition from the second performance point to the first performance point based on the detected usage rising above the first threshold.

20. The system of claim 15 wherein the usage level comprises a utilization percentage or a bandwidth value.
